(19) United States
(12) Patent Application Publication
(10) Pub. No.: US 2019/0163436 A1
(43) Pub. Date: May 30, 2019

(54) ELECTRONIC DEVICE AND METHOD FOR CONTROLLING THE SAME

(71) Applicant: LG ELECTRONICS INC., Seoul (KR)

(72) Inventor: Sohyun AHN, Seoul (KR)

(73) Assignee: LG ELECTRONICS INC., Seoul (KR)

(21) Appl. No.: 15/954,372

(22) Filed: Apr. 16, 2018

(30) Foreign Application Priority Data
Nov. 28, 2017 (KR) 10-2017-0160594

(51) Int. Cl. G06F 3/16; H04L 29/08

(52) U.S. Cl. CPC G06F 3/167; H04W 88/02; H04L 67/10

(57) ABSTRACT

An electronic device that provides digital contents by using artificial intelligence is disclosed. The electronic device comprises a communication unit for performing communication with an external server in which a plurality of contents are stored; an output unit for outputting a specific one of the plurality of contents on the basis of a user control command; a learning data unit for learning user information related to contents; and a controller for downloading a specific one of the plurality of contents on the basis of the learned result of the user information and outputting the downloaded specific content to the output unit, wherein the controller converts an output format of the specific content to be matched with an output format of the output unit if the output format of the specific content is different from that of the output unit.

### CROSS-REFERENCE TO RELATED APPLICATIONS

Pursuant to 35 U.S.C. § 119(a), this application claims the benefit of earlier filing date and right of priority to Korean Patent Application No. 10-2017-0160594, filed on Nov. 28, 2017, the contents of which are hereby incorporated by reference herein in its entirety.

### BACKGROUND OF THE INVENTION

### 1. Field of the Invention

The present invention relates to an electronic device that provides digital contents by using artificial intelligence.

### 2. Description of the Related Art

Recently, with the development of hardware, artificial intelligence technology, which implements a thinking process of a person, such as cognition, inference and learning, through computing technique, has been rapidly developed.

The artificial intelligence technology is a resource object and may be connected with the other fields of computer science directly or indirectly to provide various functions. Particularly, artificial intelligence elements have been introduced in various fields of information technology, whereby attempts to utilize the artificial intelligence elements for solution to problems in the corresponding field have been actively made.

The artificial intelligence technology is categorized into strong artificial intelligence and weak artificial intelligence. Strong artificial intelligence is a technique that can think and make a decision similarly to a human being, and is also a technique that makes a self-decision through self-learning. Weak artificial intelligence is a technique that provides an optimal solution by performing a cognition process such as perception and inference through a computation model.

As a part of such technology development, attempts to provide various functions by applying the artificial intelligence technology to an electronic device most familiar with users have been increased.

Particularly, studies related to enlargement of application of the artificial intelligence technology in accordance with connection of the electronic device with another device have been actively performed. As an example, the electronic device may be connected with the other device on the basis of a user's speech received therein, and an input of a control command for the connected device may be performed through the electronic device.

Meanwhile, easiness of an approach to media contents has been improved by the development of communication technology. However, for this reason, inconvenience has occurred in that the user should search for preferred contents among massive media contents in detail.

In this respect, attempts to provide user-customized contents by combining artificial intelligence technology with media contents have been recently increased. However, since contents are recommended considering a user's taste only without consideration of various other elements such as the user's feeling until now, same or similar contents are always provided, whereby the user may be tired of the contents and thus the contents are lack of practical use.

Also, in accordance with the development of various types of electronic devices, if an output format of the electronic device and an output format of media contents are different from each other, a problem has occurred in that the user fails to view media contents.

### SUMMARY OF THE INVENTION

Therefore, an object of the present invention devised to substantially obviate one or more problems due to limitations and disadvantages of the related art is to provide contents optimized for a user by using artificial intelligence technology.

Another object of the present invention is to generate contents customized for a user considering the user's taste and properties of contents.

To achieve these and other advantages and in accordance with the purpose of the invention, as embodied and broadly described herein, an electronic device according to the present invention comprises a communication unit for performing communication with an external server in which a plurality of contents are stored; an output unit for outputting at least one of the plurality of contents on the basis of a user control command; a learning data unit for learning user information related to contents; and a controller for downloading at least one of the plurality of contents on the basis of the user information and outputting the downloaded content to the output unit, wherein the controller converts an output format of the at least one content if the output format of the at least one content is different from that of the output unit.

In one embodiment, the controller generates a play list in which the at least one content is included, on the basis of the user information.

In one embodiment, the controller determines the play list of the at least one content considering least one of emotion information of a user, atmosphere information in the periphery of the user, and weather information.

In one embodiment, when the at least one content is played in due order and a content which is currently played is converted to another content, the controller determines a play conversion time between the contents considering attribute information of the content which is currently played and attribute information of the other content.

In one embodiment, the electronic device further comprises a sensing unit for sensing information related to a peripheral environment of a user, wherein the controller extracts the user's preferred content information according to the information related to the peripheral environment on the basis of the user information and downloads at least one of the plurality of contents stored in the external server, on the basis of the extracted preferred content information.

In one embodiment, the communication unit is able to perform communication with at least one external device located in the periphery of the electronic device, and the controller controls an operation of the external device on the basis of the information related to the peripheral environment if at least one content is output through the output unit.

In one embodiment, the controller generates a control command for controlling the operation of the external device on the basis of the information related to the peripheral environment, and transmits the generated control command to the external device through communication.

In one embodiment, if output of the at least one content ends, the controller generates a control command for returning the operation of the external device to the state that the output of the at least one content starts, and transmits the generated control command to the external device.

In one embodiment, the output unit is formed to output speech information, and the controller converts visual information of the at least one content to speech information and outputs the converted speech information through the output unit on the basis of a preset image recognition algorithm if the at least one content is the visual information, and outputs only speech information through the output unit if the at least one content includes the visual information and the speech information.

In one embodiment, the electronic device further comprises a memory for storing contents, wherein the controller extracts at least one of the contents stored in the memory and the plurality of contents stored in the external server, on the basis of the user information, and synthesizes the contents stored in the memory with the extracted content to generate a new content.

In one embodiment, the controller detects partial contents from the extracted content on the basis of the user information, and generates a synthesis image by using the detected partial contents.

In one embodiment, the controller learns attribute information of at least one of a content having a play history, a content having a reading history, and a content having a viewing history, and the attribute information of the content includes scene information, character information of the content, and context information.

In one embodiment, a content providing system comprises an external server for storing a plurality of contents; and a mobile terminal for receiving at least one of the plurality of contents through communication with the external server, wherein the external server extracts at least one of the plurality of contents on the basis of user information of the mobile terminal, sets an output format of the extracted content on the basis of a content output format of the mobile terminal, and transmits the at least one content having the set output format to the mobile terminal, and the mobile terminal outputs the transmitted specific content.

In one embodiment, the mobile terminal transmits information related to a peripheral environment of the mobile terminal to the external server, and the external server sets an output format of the extracted content on the basis of the information related to the peripheral environment of the mobile terminal.

The electronic device according to the embodiment of the present invention may download at least one content suitable for the user's taste from the server in which the plurality of contents are stored. If the output format of the downloaded content is different from that of the electronic device, the output format of the at least one content may be changed to the suitable format and then output to the output unit of the electronic device, whereby a problem that the content cannot be output due to the different output formats of the contents may be solved.

Also, the electronic device according to another embodiment of the present invention may download at least one content suitable for the user's taste from the server in which the plurality of contents are stored, and may synthesize the downloaded content with the content stored in the memory of the electronic device on the basis of the user information to generate a new content, whereby contents optimized for the user may be produced easily.

Also, in the present invention, when a play list in which the plurality of contents are included is generated, a play order and a play conversion time may be set considering the user information and the atmosphere, whereby more optimal contents may be recommended for the user.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the detailed description.

### BRIEF DESCRIPTION OF THE DRAWING

The accompanying drawings, which are included to provide a further understanding of the invention and are incorporated in and constitute a part of this specification, illustrate exemplary embodiments and together with the description serve to explain the principles of the invention.

In the drawings:

FIG. 1 is a conceptual view illustrating an electronic device according to the present invention, which performs communication with an external device for outputting contents;

FIG. 2A is a block diagram illustrating an electronic device according to the present invention;

FIG. 2B is a conceptual view illustrating an example of an electronic device, that is, a speaker type electronic device according to the present invention;

FIG. 3 is a conceptual view illustrating a digital assistant for input processing;

FIG. 4 is a flow chart illustrating an operation method of an electronic device and a server to output contents from the electronic device according to the present invention;

FIG. 5 is a flow chart illustrating a method for processing contents;

FIGS. 6A to 6C are conceptual views illustrating a control method of FIG. 5;

FIG. 7 is a flow chart illustrating a method for generating a play list in an electronic device according to the present invention;

FIGS. 8A to 8C are views illustrating contents related to a play list;

FIG. 9 is a flow chart illustrating a method for configuring a peripheral environment information of an electronic device when contents are played; and

FIG. 10 is a conceptual view illustrating a method for controlling external devices to configure a peripheral environment.

### DETAILED DESCRIPTION OF THE PREFERRED EMBODIMENT

Description will now be given in detail according to exemplary embodiments disclosed herein, with reference to the accompanying drawings. For the sake of brief description with reference to the drawings, the same or equivalent components may be provided with the same or similar reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In describing the present disclosure, if a detailed explanation for a related known function or construction is considered to unnecessarily divert the gist of the present disclosure, such explanation has been omitted but would be understood by those skilled in the art. The accompanying drawings are used to help easily understand the technical idea of the present disclosure and it should be understood that the idea of the present disclosure is not limited by the accompanying drawings. The idea of the present disclosure should be construed to extend to any alterations, equivalents and substitutes besides the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the another element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

Electronic devices presented herein may be implemented using a variety of different types of terminals. Examples of such devices include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of electronic devices. In addition, these teachings may also be applied to stationary terminals such as digital TV, desktop computers, digital signages, and the like.

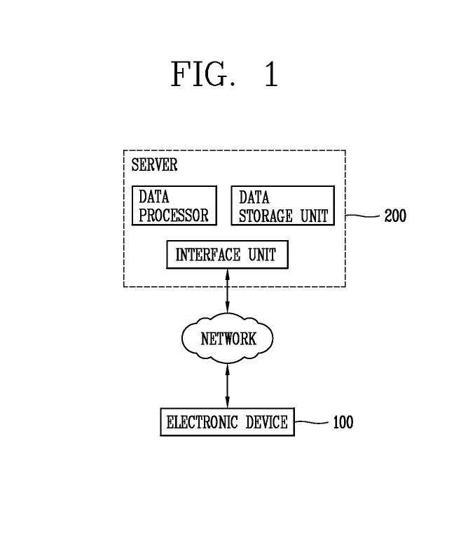

Referring to FIG. 1, in the present invention, the electronic device 100 and the server 200 may transmit and receive contents to and from each other through network communication.

Referring to FIG. 1, in the present invention, the server 200 and the electronic device 100 may be formed to perform communication with each other through a network.

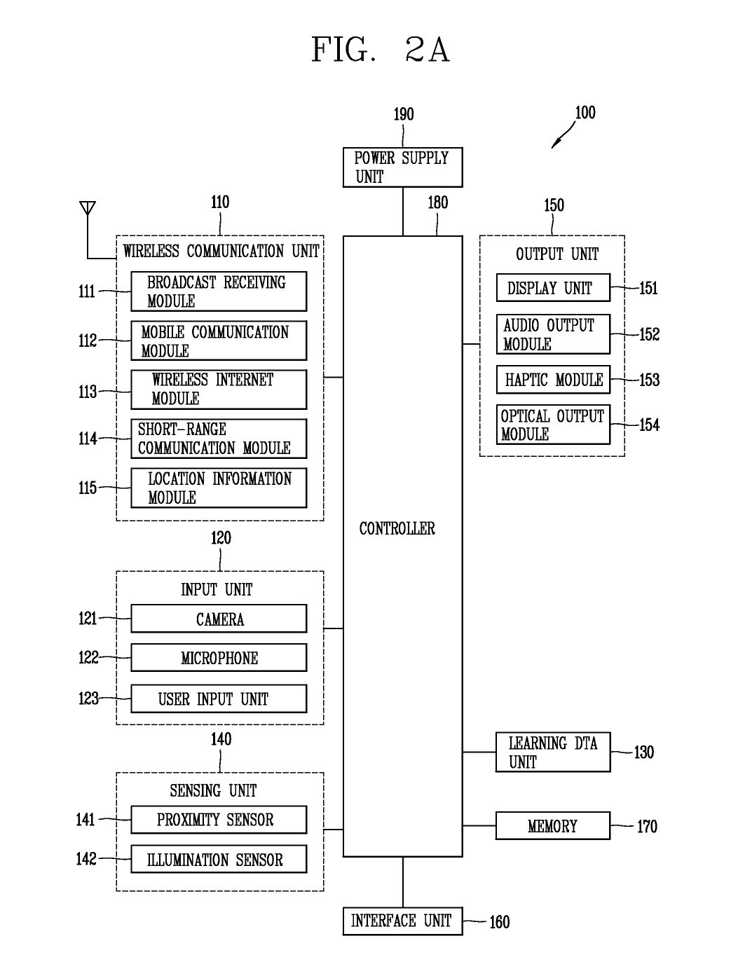

The server 200 may include a data processor and a data memory, and may further include an interface unit for transmitting and receiving data to and from the electronic device 100. The data processor is a module for processing data requested from the electronic device, and may perform the role similar to that of a controller which will be described with reference to FIG. 2A. Since the data memory performs the same role as that of a learning data unit of FIG. 2A, its detailed description will be replaced with that of FIG. 2A.

Hereinafter, FIG. 2A is a block diagram illustrating an electronic device according to the present invention, and FIG. 2B is a conceptual view illustrating an example of an electronic device, that is, a speaker type electronic device according to the present invention.

The electronic device 100 may be shown having components such as a wireless communication unit 110, an input unit 120, a sensing unit 140, an output unit 150, an interface unit 160, a memory 170, a controller 180, and a power supply unit 190. It is understood that implementing all of the illustrated components in FIG. 2A is not a requirement, and that greater or fewer components may alternatively be implemented.

In more detail, among others, the wireless communication unit 110 may typically include one or more modules which permit communications such as wireless communications between the electronic device 100 and a wireless communication system, communications between the electronic device 100 and another electronic device, or communications between the electronic device 100 and an external server. Further, the wireless communication unit 110 may typically include one or more modules which connect the mobile electronic device 100 to one or more networks.

The wireless communication unit 110 may include one or more of a broadcast receiving module 111, a mobile communication module 112, a wireless Internet module 113, a short-range communication module 114, and a location information module 115.

The input unit 120 may include a camera 121 or an image input unit for obtaining images or video, a microphone 122, which is one type of audio input device for inputting an audio signal, and a user input unit 123 (for example, a touch key, a mechanical key, and the like) for allowing a user to input information. Data (for example, audio, video, image, and the like) may be obtained by the input unit 120 and may be analyzed and processed according to user commands.

The sensing unit 140 may typically be implemented using one or more sensors configured to sense internal information of the electronic device, the surrounding environment of the electronic device, user information, and the like. For example, the sensing unit 140 may include at least one of a proximity sensor 141, an illumination sensor 142, a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like). The electronic device disclosed herein may be configured to utilize information obtained from one or more sensors of the sensing unit 140, and combinations thereof.

The output unit 150 may typically be configured to output various types of information, such as audio, video, tactile output, and the like. The output unit 150 may be shown having at least one of a display unit 151, an audio output module 152, a haptic module 153, and an optical output module 154. The display unit 151 may have an inter-layered structure or an integrated structure with a touch sensor in order to implement a touch screen. The touch screen may function as the user input unit 123 which provides an input interface between the electronic device 100 and the user and simultaneously provide an output interface between the electronic device 100 and a user.

The interface unit 160 serves as an interface with various types of external devices that are coupled to the electronic device 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the electronic device 100 may perform assorted control functions associated with a connected external device, in response to the external device being connected to the interface unit 160.

The memory 170 is typically implemented to store data to support various functions or features of the electronic device 100. For instance, the memory 170 may be configured to store application programs executed in the electronic device 100, data or instructions for operations of the electronic device 100, and the like. Some of these application programs may be downloaded from an external server via wireless communication. Other application programs may be installed within the electronic device 100 at time of manufacturing or shipping, which is typically the case for basic functions of the electronic device 100 (for example, receiving a call, placing a call, receiving a message, sending a message, and the like). It is common for application programs to be stored in the memory 170, installed in the electronic device 100, and executed by the controller 180 to perform an operation (or function) for the electronic device 100.

The controller 180 typically functions to control an overall operation of the electronic device 100, in addition to the operations associated with the application programs. The controller 180 may provide or process information or functions appropriate for a user by processing signals, data, information and the like, which are input or output by the aforementioned various components, or activating application programs stored in the memory 170.

Also, the controller 180 may control at least some of the components illustrated in FIG. 2A, to execute an application program that have been stored in the memory 170. In addition, the controller 180 may control at least two of those components included in the electronic device to activate the application program.

The power supply unit 190 may be configured to receive external power or provide internal power in order to supply appropriate power required for operating elements and components included in the electronic device 100. The power supply unit 190 may include a battery, and the battery may be configured to be embedded in the terminal body, or configured to be detachable from the terminal body.

At least part of the components may cooperatively operate to implement an operation, a control or a control method of an electronic device according to various embodiments disclosed herein. Also, the operation, the control or the control method of the electronic device may be implemented on the electronic device by an activation of at least one application program stored in the memory 170.

Hereinafter, description will be given in more detail of the aforementioned components with reference to FIG. 2A, prior to describing various embodiments implemented through the electronic device 100.

First, regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneous reception of two or more broadcast channels, or to support switching among broadcast channels.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like).

The wireless signal may include various types of data depending on a voice call signal, a video call signal, or a text/multimedia message transmission/reception.

The wireless Internet module 113 refers to a module for wireless Internet access. This module may be internally or externally coupled to the electronic device 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), High Speed Uplink Packet Access (HSUPA), Long Term Evolution (LTE), LTE-advanced (LTE-A) and the like. The wireless Internet module 113 may transmit/receive data according to one or more of such wireless Internet technologies, and other Internet technologies as well.

When the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the electronic device 100 and a wireless communication system, communications between the electronic device 100 and another electronic device, or communications between the electronic device and a network where another electronic device (or an external server) is located, via wireless area networks. One example of the wireless area networks is a wireless personal area networks.

Here, another electronic device (which may be configured similarly to the electronic device 100) may be a wearable device, for example, a smart watch, a smart glass or a head mounted display (electronic device), which is able to exchange data with the electronic device 100 (or otherwise cooperate with the electronic device 100). The short-range communication module 114 may sense or recognize the wearable device, and permit communication between the wearable device and the electronic device 100. In addition, when the sensed wearable device is a device which is authenticated to communicate with the electronic device 100, the controller 180, for example, may cause transmission of at least part of data processed in the electronic device 100 to the wearable device via the short-range communication module 114. Hence, a user of the wearable device may use the data processed in the electronic device 100 on the wearable device. For example, when a call is received in the electronic device 100, the user may answer the call using the wearable device. Also, when a message is received in the electronic device 100, the user can check the received message using the wearable device.

The location information module 115 is a module for acquiring a position (or a current position) of the electronic device 100. As an example, the location information module 115 includes a Global Position System (GPS) module or a Wi-Fi module. For example, when the electronic device uses a GPS module, a position of the electronic device may be acquired using a signal sent from a GPS satellite. As another example, when the electronic device uses the Wi-Fi module, a position of the electronic device may be acquired based on information related to a wireless access point (AP) which transmits or receives a wireless signal to or from the Wi-Fi module. If desired, the location information module 115 may alternatively or additionally function with any of the other modules of the wireless communication unit 110 to obtain data related to the position of the electronic device. The location information module 115 is a module used for acquiring the position (or the current position) of the electronic device, and may not be limited to a module for directly calculating or acquiring the position of the electronic device.

Next, the input unit 120 is configured to permit various types of inputs to the electronic device 100. Examples of such inputs include image information (or signal), audio information (or signal), data or various information input by a user, and may be provided with one or a plurality of cameras 121. Such cameras 121 may process image frames of still pictures or video obtained by image sensors in a video or image capture mode. The processed image frames can be displayed on the display unit 151 or stored in memory 170. Meanwhile, the cameras 121 provided in the electronic device 100 may be arranged in a matrix configuration to permit a plurality of images having various angles or focal points to be input to the electronic device 100. Also, the cameras 121 may be located in a stereoscopic arrangement to acquire left and right images for implementing a stereoscopic image.

The microphone 122 processes an external audio signal into electric audio (sound) data. The processed audio data may be processed in various manners according to a function being executed in the electronic device 100. If desired, the microphone 122 may include assorted noise removing algorithms to remove unwanted noise generated in the course of receiving the external audio signal. The user input unit 123 is a component that permits input by a user. Such user input may enable the controller 180 to control operation of the electronic device 100. The user input unit 123 may include a mechanical input element (or a mechanical key, for example, a button located on a front and/or rear surface or a side surface of the electronic device 100, a dome switch, a jog wheel, a jog switch, and the like), or a touch-sensitive input element, among others. As one example, the touch-sensitive input element may be a virtual key, a soft key or a visual key, which is displayed on a touch screen through software processing, or a touch key which is located on the electronic device at a location that is other than the touch screen. On the other hand, the virtual key or the visual key may be displayed on the touch screen in various shapes, for example, graphic, text, icon, video, or a combination thereof.

A learning data unit 130 may be configured to receive, classify, store and output information which will be used for data mining, data analysis, intelligent decision and machine learning algorithm and technology. The learning data unit 130 may include one or more memory units configured to store information received, detected, sensed and predefined through a terminal or information output through the terminal in another way or store data received, detected, sensed, predefined or output by another element, device and terminal.

The learning data unit 130 may include a memory unified or provided in the electronic device. In one embodiment, the learning data unit 130 may be implemented through the memory 170. However, without limitation to this memory, the learning data unit 130 may be implemented in a memory (for example, external memory connected to the electronic device 100 (by cable or electrically)) related to the electronic device 100, or may be implemented through a memory included in a server that may perform communication with the electronic device 100. In other embodiment, the learning data unit 130 may be implemented through a memory maintained in a cloud computing environment or another remote memory accessible by the terminal through a communication system such as a network.

The learning data unit 130 is configured to store data used for supervised or unsupervised learning, data mining, prediction analysis or other machine learning technique in one or more databases to identify, index, classify, manipulate, store, search and output the data. Information stored in the learning data unit 130 may be used by a controller 180, which uses at least one of data analysis of different types, machine learning algorithm and machine learning technique or a plurality of controllers included in the electronic device. Examples of these algorithms and techniques include a k-Nearest neighbor system, fuzzy logic (for example, possibility theory), neural networks, Boltzmann machines, vector quantization, pulsed neural nets, support vector machines, maximum margin classifiers, hill-climbing, inductive logic systems, baysian networks, petri nets (for example, finite state machines, mealy machines, and moore finite state machines), classifier trees (for example, perceptron trees, support vector trees, markov trees, decision tree forests, and random forests), pandemonium models and systems, clustering, artificially intelligent planning, artificially intelligent forecasting, data fusion, sensor fusion, image fusion, reinforcement learning, augmented reality, pattern recognition, automated planning, etc.

The controller 180 may determine or predict at least one executable operation of the electronic device on the basis of information determined or generated using data analysis, machine learning algorithm and machine learning technology. To this end, the controller 180 may request, search, receive or use data of the learning data unit 130. The controller 180 may perform various functions for implementing a knowledge based system, an inference system and a knowledge acquisition system, and may perform various functions including a system (for example, fuzzy logic system) for uncertain inference, an adaptive system, a machine learning system, artificial neural nets, etc.

The controller 180 may include sub modules that enable speech and natural language processing, such as an I/O processing module, an environment condition module, a speech-text (STT) processing module, a natural language processing module, a task flow processing module, and a service processing module. Each of the sub modules may have an access power for one or more systems or data and model, or their subset or superset in the electronic device. In this case, targets accessible by each of the sub modules may include scheduling, vocabulary index, user data, task flow model, service model and automatic speech recognition (ASR) system. In another embodiment, the controller 180 or the electronic device may be implemented as the sub module, system or data and model.

In some embodiment, based on data in the learning data unit 130, the controller 180 may be configured to detect and sense a user request on the basis of a user input, a context condition expressed by natural language input or a user's intention. Also, the controller 180 may actively derive or acquire information required to completely determine a user request in accordance with the context condition or the user's intention. For example, the controller 180 may detect and sense the user request by analyzing past data that include past input and output, pattern matching, unambiguous word, and input intention. Also, the controller 180 may determine a task flow for executing a function requested by the user in accordance with the context condition or the user's intention. Also, the controller 180 may execute a task flow for fulfilling the user request on the basis of the context condition or the user's intention.

In some embodiment, the controller 180 may implement dedicated hardware elements for a learning data process, which includes a memistor, memristors, mutual conductance amplifier, pulse type neural circuit, artificial intelligent type nano technology system (for example, autonomic nano machines) or artificial intelligent type quantum machine system (for example, quantum neural network). In some embodiment, the controller 180 may include a machine vision system, a speech recognition system, a writing recognition system, a data fusion system, a sensor fusion system, and a pattern recognition system such as soft sensor. The machine vision system may include contents based image search, optical text recognition, augmented reality, egomotion, tracking and optical flow, etc.

The controller 180 may sense or receive information inside the electronic device, environment information surrounding the electronic device, or other information through the sensing unit 140. Also, the controller 180 may receive a broadcast signal and/or broadcasting related information, a radio signal, radio data, etc. through the wireless communication unit 110. Also, the controller 180 may receive video information (or corresponding signal), audio information (or corresponding signal), data, or information input from the user, from the input unit.

The controller 180 may collect the above information, process or classify (for example, knowledge graph, command language policy, personal database, conversation engine, etc.) the collected information, and store the processed or classified information in the memory 170 or the learning data unit 130.

If the operation of the electronic device is determined based on data analysis, machine learning algorithm and machine learning technique, the controller may control component elements of the electronic device to execute the determined operation. The controller 180 may execute the determined operation by controlling the electronic device on the basis of a control command.

In one embodiment, if a specific operation is performed, the controller 180 may analyze history information indicating that the specific operation is performed, through data analysis, machine learning algorithm and machine learning technique, and may update information learned conventionally, on the basis of the analyzed information. Therefore, the controller 180 may improve accuracy of future performance of data analysis, machine learning algorithm and machine learning technique based on the updated information together with the learning data unit 130.

The sensing unit 140 is generally configured to sense one or more of internal information of the electronic device, surrounding environment information of the electronic device, user information, or the like, and generate a corresponding sensing signal. The controller 180 generally cooperates with the sending unit 140 to control operation of the electronic device 100 or execute data processing, a function or an operation associated with an application program installed in the electronic device 100 based on the sensing signal. The sensing unit 140 may be implemented using any of a variety of sensors, some of which will now be described in more detail.

The proximity sensor 141 refers to a sensor to sense presence or absence of an object approaching a surface, or an object located near a surface, by using an electromagnetic field, infrared rays, or the like without a mechanical contact. The proximity sensor 141 may be arranged at an inner region of the electronic device covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like). In general, controller 180 processes data corresponding to proximity touches and proximity touch patterns sensed by the proximity sensor 141, and cause output of visual information on the touch screen. In addition, the controller 180 may control the electronic device 100 to execute different operations or process different data (or information) according to whether a touch with respect to a point on the touch screen is either a proximity touch or a contact touch.

A touch sensor can sense a touch (or a touch input) applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

Meanwhile, the controller 180 may execute the same or different controls according to a type of touch object that touches the touch screen or a touch key provided in addition to the touch screen. Whether to execute the same or different control according to a type of an object which provides a touch input may be decided based on a current operating state of the electronic device 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize location information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121, which has been depicted as a component of the input unit 120, typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors (TRs) at rows and columns to scan content received at the photo sensor using an electrical signal which changes according to the quantity of applied light. Namely, the photo sensor may calculate the coordinates of the physical object according to variation of light to thus obtain location information of the physical object.

The display unit 151 is generally configured to output information processed in the electronic device 100. For example, the display unit 151 may display execution screen information of an application program executing at the electronic device 100 or user interface (UI) and graphic user interface (GUI) information in response to the execution screen information.

Also, the display unit 151 may be implemented as a stereoscopic display unit for displaying stereoscopic images.

A typical stereoscopic display unit may employ a stereoscopic display scheme such as a stereoscopic scheme (a glass scheme), an auto-stereoscopic scheme (glassless scheme), a projection scheme (holographic scheme), or the like. The audio output module 152 may receive audio data from the wireless communication unit 110 or output audio data stored in the memory 170 during modes such as a signal reception mode, a call mode, a record mode, a voice recognition mode, a broadcast reception mode, and the like. The audio output module 152 may provide audible output related to a particular function (e.g., a call signal reception sound, a message reception sound, etc.) performed by the electronic device 100. The audio output module 152 may also be implemented as a receiver, a speaker, a buzzer, or the like.

A haptic module 153 can be configured to generate various tactile effects that a user feels, perceives, or otherwise experiences. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the electronic device 100.

An optical output module 154 may output a signal for indicating an event generation using light of a light source of the electronic device 100. Examples of events generated in the electronic device 100 may include message reception, call signal reception, a missed call, an alarm, a schedule notice, an email reception, information reception through an application, and the like.

A signal output by the optical output module 154 may be implemented in such a manner that the electronic device emits monochromatic light or light with a plurality of colors. The signal output may be terminated as the electronic device senses that a user has checked the generated event, for example.

The interface unit 160 serves as an interface for external devices to be connected with the electronic device 100. For example, the interface unit 160 can receive data transmitted from an external device, receive power to transfer to elements and components within the electronic device 100, or transmit internal data of the electronic device 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the electronic device 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the electronic device 100 is connected with an external cradle, the interface unit 160 can serve as a passage to allow power from the cradle to be supplied to the electronic device 100 or may serve as a passage to allow various command signals input by the user from the cradle to be transferred to the electronic device therethrough. Various command signals or power input from the cradle may operate as signals for recognizing that the electronic device is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a flash memory type, a hard disk type, a solid state disk (SSD) type, a silicon disk drive (SDD) type, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The electronic device 100 may also be operated in relation to a network storage device that performs the storage function of the memory 170 over a network, such as the Internet.

The controller 180 may typically control operations relating to application programs and the general operations of the electronic device 100. For example, the controller 180 may set or release a lock state for restricting a user from inputting a control command with respect to applications when a status of the electronic device meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 may control one ora combination of those components in order to implement various exemplary embodiments disclosed herein.

The power supply unit 190 receives external power or provides internal power and supply the appropriate power required for operating respective elements and components included in the wearable device 100 under the control of the controller 180. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

Subsequently, referring to FIG. 2B, a speaker type electronic device is shown as an example of the electronic device 100. As shown, the speaker type electronic device 100 may include a microphone 122, a speaker 152, and a display unit 151. A writing function is built in the frame 101 of the electronic device 100, whereby the writing function may be activated in the frame in accordance with a given input. Also, a camera 121 may be provided outside the electronic device 100 to acquire peripheral images.

The electronic device 100 may be operated in any one of a standby mode and a speech recognition mode. In the standby mode, it is sensed whether speech related to execution of the speech recognition function exists in the periphery of the electronic device before the speech recognition function is executed. To this end, the controller 180 of the electronic device 100 may monitor whether a sound of a specific loudness or more is sensed continuously through the microphone 122. Also, since it is not required to perform speech analysis in the standby mode, the electronic device 100 may be operated at a low power, for example, only current of 4.4 mA. This standby mode may be referred to as a “listening phase”.

Meanwhile, in the standby mode, if the sound of the specific loudness or more is sensed through the microphone 122, the standby mode of the electronic device 100 may be switched to a speech recognition mode. Alternatively, if a given start word of the specific loudness or more is sensed through the microphone 122, the standby mode of the electronic device 100 may be switched to the speech recognition mode. In this case, the start word may include a speech command given to wake-up the electronic device 100 of the standby mode, for example, speech command such as “Hello”, “Wake up” and “Google”.

The speech recognition mode means the state that the controller 180 of the electronic device 100 analyzes speech input through the microphone 122. Since speech analysis is performed in the speech recognition mode, more current is consumed than that in a standby state 210. That is, the electronic device according to the present invention exists at the standby state 210 that speech analysis is not performed, before the start word is received, whereby consumed current may be reduced. Meanwhile, the controller 180 of the electronic device 100 may determine whether the start word starting speech recognition in the speech recognition mode has been received before speech analysis. In other words, the controller 180 may start speech analysis with respect speech uttered after the start word.

In the speech recognition mode, the electronic device 100 may analyze the speech input through the microphone 122, whereby the operation of the electronic device 100 may be controlled. This speech analysis may be performed using a separate third party application installed in the electronic device.

Also, the controller 180 of the electronic device 100 may use data transmitted to a preset artificial intelligent server or stored in the learning data unit 130 of the electronic device 100 to process speech analysis of speech information through the artificial intelligent algorithm. In this case, the preset artificial intelligent server is a server that learns massive information by using the artificial intelligent algorithm and derives optimized resultant information on the basis of the learned information. Alternatively, the controller 180 of the electronic device 100 may generate resultant information responded to the input speech information, on the basis of the data stored in the learning data unit 130.

Also, if a speech or given start word of the user is not received for a preset time in the aforementioned speech recognition mode, the speech recognition mode may be switched to the standby mode.

Subsequently, the speaker 152 may output a response result of the input speech information. This response result may include ambiguous speech information or inquiry or guide information for checking a search range as well as a response to the input speech information. Also, if the aforementioned speech recognition mode is switched to the standby mode or the standby mode is switched to the speech recognition mode, the speaker 152 may output a preset notification sound.

The display unit 151 may output a graphic object or image corresponding to the response result output through the speaker 152. Alternatively, if the speaker 152 is set to silence, the response result of the input speech information may be output through the display unit 151 only in accordance with setup of the electronic device 100. Meanwhile, if the display unit 151 is comprised of the aforementioned touch screen, the user and the electronic device 100 may perform interaction by controlling the graphic object or image on the basis of various types of touch inputs.

The camera 121 may detachably be mounted at one side of the electronic device 100. The image acquired through the camera 121 may be used to identify the user corresponding to the speech information input through the speaker 152. Alternatively, the acquired image may be transmitted to another device in accordance with a user request.

Meanwhile, the following description will be given based on that the electronic device 100 comprises the learning data unit 130 to output the analysis result of the input speech. However, the present invention is not limited to this electronic device, and the electronic device 100 may be implemented to receive a response corresponding to analysis of the speech information by performing communication with the artificial intelligent server and be operated on the basis of the received response.

Also, although the following description and drawings will be given based on that the electronic device 100 is implemented as a speaker type that outputs speech, the present invention is not limited to this electronic device, and it will be apparent to those skilled in the art that various types of electronic devices may be implemented.

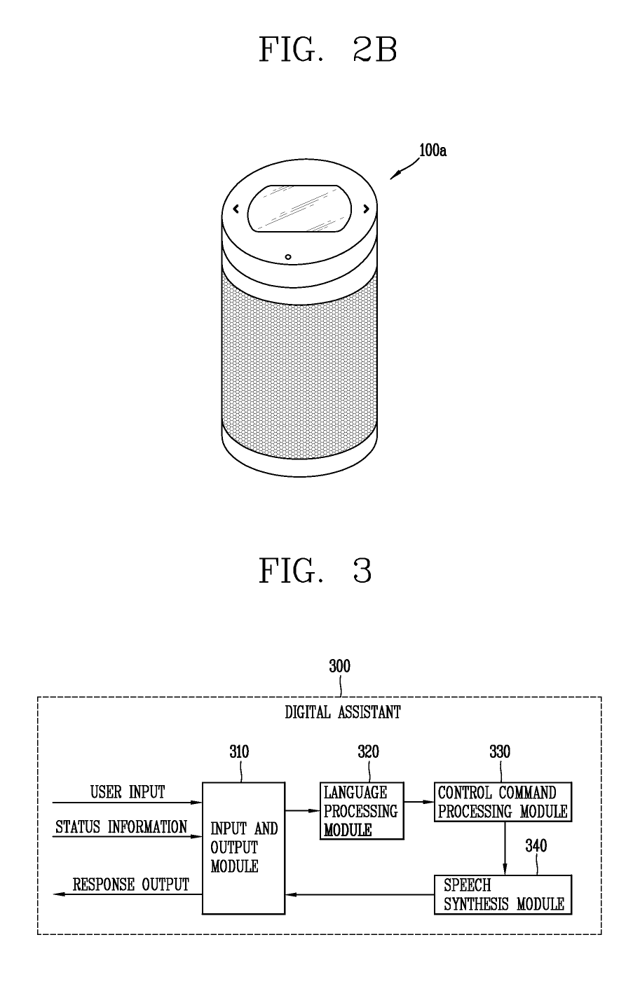

Hereinafter, in the server or electronic device according to the present invention, which stores contents, a digital assistant that performs control based on the artificial intelligent algorithm will be described. FIG. 3 is a conceptual view illustrating a digital assistant for input processing.

The digital assistant 300 may be an independent element on a computer system, or may be implemented as a part of a controller (or control module) on the computer system. Alternatively, the digital assistant 300 may be implemented to be distributed on a plurality of computers, perform mutual communication and process information. For example, the digital assistant 300 may be implemented to be distributed into a server part and an electronic device part. In this case, the server part and the electronic device part may process information while transmitting and receiving data to and from each other through a network.

The digital assistant 300 may perform at least one of a function of converting speech input to text, a natural language processing function, and an electronic device control function.

To this end, referring to FIG. 3, the digital assistant 300 may include an input and output module 310, a language processing module 320, a control command processing module 330, and a speech synthesis module 340. Meanwhile, the digital assistant 300 may further include additional modules if necessary in addition to the elements shown in FIG. 3.

The input and output module 310 may receive necessary information such as status information and user information or output a response reaction generated in response to the input information by mutually interacting with the user input unit of the electronic device or the output unit of the electronic device. The status information may include peripheral environment information related to an environment in the periphery of the electronic device, weather information, etc. The user information may include user personal information, user preference information, taste information, contact address information, character information, schedule information, etc.

The language processing module 320 may perform the function of converting speech information to text information if the information input from the input and output module 310 is speech information. The language processing module 320 may convert speech information to text information by using various speech recognition algorithms. For example, the speech recognition algorithms based on various speech recognition models such as hidden Markov models, Gaussian-Mixture Models, Deep Neural Network Models, and n-gram language models may be used.

Also, the language processing module 320 may perform the function of converting speech information to text information by further considering the user's ordinary pronunciation information. For example, the language processing module 320 may convert the same speech information to any one text information of “waiting” and “reading” in accordance with the user's ordinary pronunciation information. As a result, the language processing module 320 may improve accuracy of text conversion of the speech information.

Meanwhile, the language processing module 320 may separately include a natural language processor. The natural language processor may perform the function of converting speech information to text information by further considering status information. The status information may convert the speech information to the text information on the basis of ontology.

The ontology is information having a hierarchical structure, and the information may be classified into attributes and stored by being classified into a high class and a low class. Also, a parameter indicating connectivity between the attributes may be defined together. For example, the high class of the ontology may be classified into weather information and media search information, and related information in each group may be stored as the low class. Moreover, although not shown, a parameter indicating connectivity between weather information and media information may be stored together.

The language processing module 320 may convert the speech information to the text information to be suitable for the user's intention by converting the speech information to the text information on the basis of the ontology.

The control command processing module 330 may generate a control command for controlling the operation of the electronic device on the basis of the text information received from the language processing module 320. Also, the control command processing module 330 may control the operation of the electronic device on the basis of the generated control command. For example, the control command processing module 330 may control the electronic device to generate a control command for searching for weather information and search for the weather information.

The speech synthesis module 340 may generate response information for the operation result of the electronic device processed by the control command processing module 330 as speech information. For example, if information indicating that today's weather is fine is searched, the speech synthesis module 340 may generate speech information indicating that “today's weather is fine”. The speech synthesis module 340 may transmit the generated speech information to the input and output module 310 to output such speech information.

The speech synthesis module 340 may use various synthesis schemes to generate speech information. For example, the speech information may be generated through various synthesis schemes such as concatenative synthesis, unit selection synthesis, diphone synthesis, domain-specific synthesis, Formant synthesis, Articulatory synthesis, HMM (hidden Markov model) based synthesis, and sine wave synthesis.

The digital assistant for processing speech information has been described in the present invention. Hereinafter, although the present invention will be described based on that the digital assistant is provided in the server unless mentioned separately, the digital assistant may be provided in the electronic device as described above, and it will be apparent that the digital assistant may be provided by being distributed into the server and the electronic device.

Hereinafter, although the present invention will be described based on that a control method is provided in the server unless mentioned separately, the digital assistant may be provided in the electronic device as described above, and it will be apparent that the digital assistant may be provided by being distributed into the server and the electronic device.

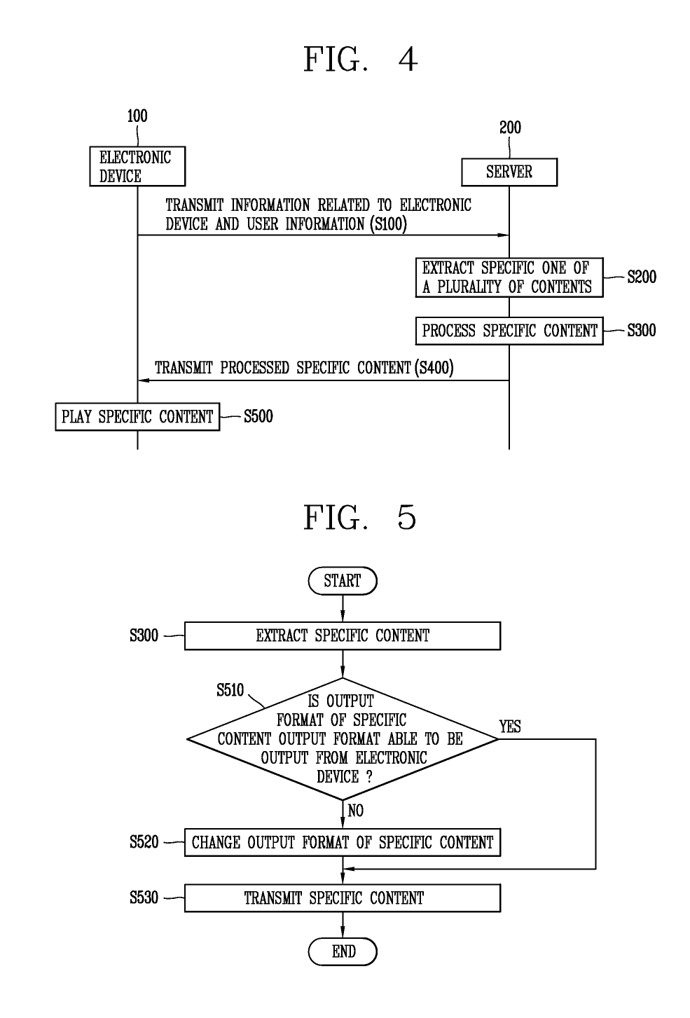

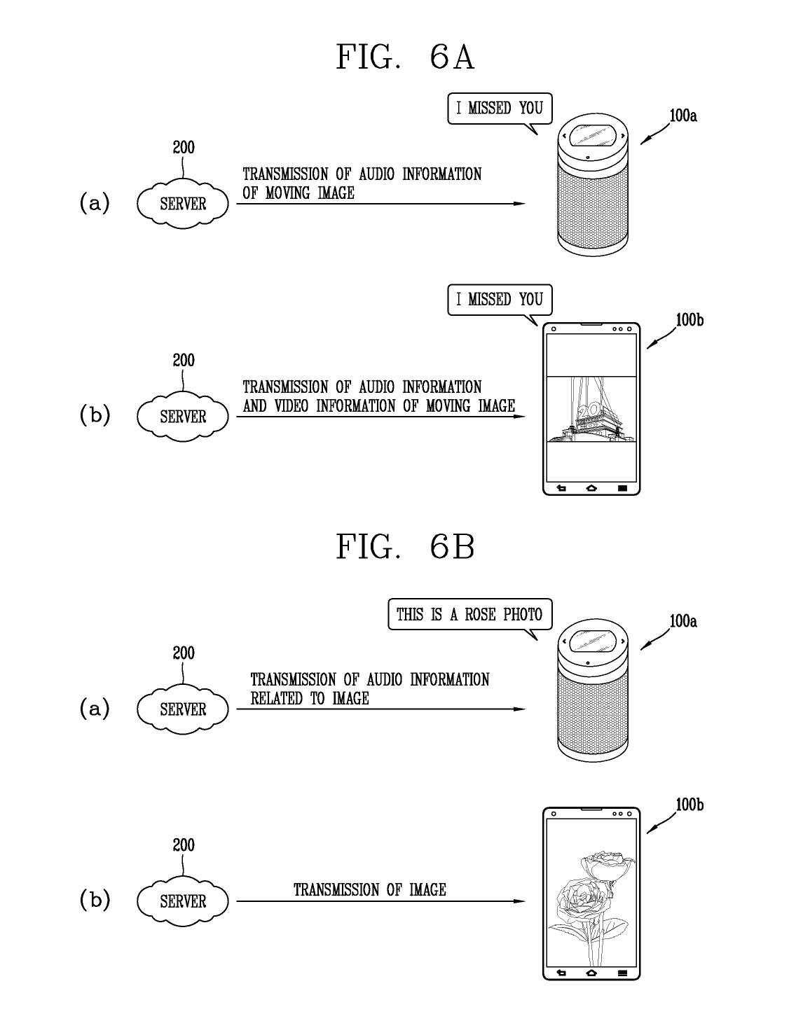

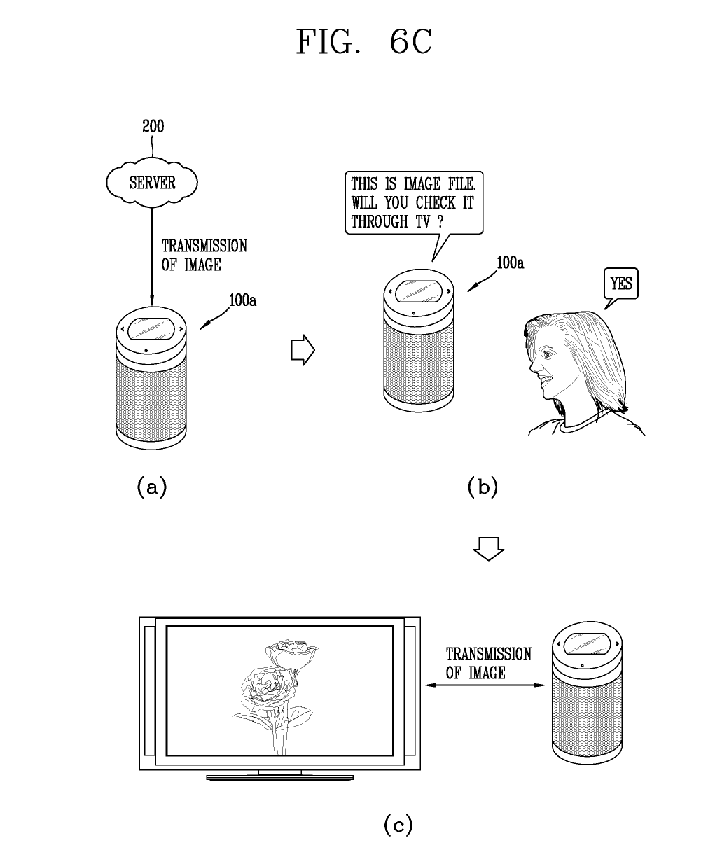

Hereinafter, a method for outputting contents from the electronic device according to the present invention will be described. FIG. 4 is a flow chart illustrating an operation method of an electronic device and a server to output contents from the electronic device according to the present invention. Also, FIG. 5 is a flow chart illustrating a method for processing contents, and FIGS. 6A to 6C are conceptual views illustrating a control method of FIG. 5.

Referring to FIG. 4, first of all, in the present invention, communication between the electronic device 100 and the server 200 may be performed through a network.

The controller 180 of the electronic device 100 may transmit information related to the electronic device and user information to the server 200 through the network (S100). The information related to the electronic device may include information indicating an output format that enables output of information from the electronic device, identification information of the electronic device, etc.

The user information may include user's preference information, contents information having a play history, contents information having a reading history, contents information having a viewing history, and personal information such as user's gender and user's age. The user information may be learned by the learning data unit 130. The controller 180 may transmit the learned user information to the server 200 through the network.

Although not shown, in addition to the learned user information, information related to an environment in the periphery of the electronic device 100, weather information, etc. may be transmitted to the server 200.

The server 200 may receive the information related to the electronic device and the user information from the electronic device 100 through the network.

The server 200 may include a database unit in which a plurality of contents are stored. The plurality of contents may include sound source contents, moving image contents, e-book, games, and images. The contents stored in the server 200 may be stored in the database unit of the server by a provider of the server, and may be received from an external device through network communication. For example, a user of a mobile terminal, which may perform communication with the server, may transmit specific contents to the server through the network.

If the information related to the electronic device and the user information are received from the electronic device 100, the server 200 may extract specific contents of the plurality of contents on the basis of a learning result learned from the information related to the electronic device and the user information (S200).

In more detail, the server 200 may learn the information related to the electronic device and the user information by using an algorithm constructed by itself, and may extract a specific content of the plurality of contents on the basis of the learning result. Therefore, the user of the electronic device 100 may acquire contents suitable for his/her taste even though the user does not search for massive contents directly.

Meanwhile, the specific content may have an output format different from a format that may be output from the electronic device 100. For example, if the electronic device 100 is a speaker, an output format of contents that may be output from the electronic device 100 is an audio format that may be output acoustically. Meanwhile, if the specific content corresponds to music video, the output format may have both a video format that may be output visually, and an audio format, and if the specific content corresponds to a sound source content, the output format may have an audio format.

The server 200 may generate indexing information related to the output format of the specific content on the basis of attribute information of the extracted specific content. The indexing information may include optimal output format information of contents, output format information that may output contents, and information related to a peripheral environment for contents output, on the basis of the attribute information of the specific content. For example, video output format information may be set to indexing information of image in an optimal output format, and the output format that may be output may include an audio output format and a video output format. This indexing information may be generated by the server 200, or may be generated by the controller of the electronic device 100.

The server 200 may compare the output format of the extracted specific content with the output format of the electronic device by using the indexing information. The server 200 may process the output format of the specific content if the output format of the extracted specific content and the output format of the electronic device are different from each other (S300).

In more detail, referring to FIG. 5, the server 200 may determine whether the output format of the extracted specific content is the output format that may be output from the electronic device, by using the indexing information (S510).

As a result, if the output format of the specific content is the output format that may be output from the electronic device, the server 200 may immediately transmit the specific content to the electronic device 100 (S530). For example, as shown in (b) of FIG. 6A, if the specific content is a moving image that includes audio information and video information and the electronic device 100 is a mobile terminal that may play the moving image, the server 200 may immediately transmit the specific content without processing the specific content. For another example, as shown in (b) of FIG. 6B, if the specific content is an image and the electronic device 100 is a mobile terminal that may output an image, the server 200 may immediately transmit the specific content without processing the specific content.

However, if the output format of the specific content is not the format that may be output from the electronic device, the server 200 may convert the indexing information and the output format of the specific content of the electronic device 100 (S520). Afterwards, the server 200 may transmit the converted specific content to the electronic device 100 (S530).

The conversion may be performed in various formats.

For example, the server 200 may transmit only some information of the contents to the electronic device 100 by considering the indexing information and the output format of the electronic device 100. For example, as shown in (a) of FIG. 6A, if the specific content is a moving image that includes audio information and video information and the electronic device 100 is a speaker that may play audio information, the server 200 may extract audio information from the moving image and transmit only the audio information to the electronic device 100.

For another example, the server 200 may convert the output format of the contents and then transmit the converted output format to the electronic device 100 by considering the indexing information and the output format of the electronic device 100. For example, as shown in (a) of FIG. 6B, if the specific content is a photo and the electronic device 100 is a speaker, the server 200 may detect information related to the photo (for example, information of a subject included in the photo, atmosphere of the photo, place, etc.) by using an image recognition algorithm and convert the detected information related to the photo to speech information. The server 200 may transmit the converted information related to the photo to the speaker.

Also, the server 200 may change an attribute of the specific content on the basis of the information related to the electronic device 100. Attribute information of the content may include at least one of character information of the content, summary information, atmosphere information, scene information, definition, brightness, resolution, picture quality, memory capacity, transmission capacity, volume, file type, equalizer, and file size.

For example, the server 200 may change resolution of the specific content on the basis of the information related to the electronic device 100. In more detail, the server 200 may lower resolution of the specific content if resolution of the specific content is higher than maximum resolution that may be output from the electronic device 100.

For another example, the server 200 may change memory capacity of the specific content on the basis of the information related to the electronic device 100. In more detail, the server 200 may edit memory capacity of the specific content to become smaller by considering memory capacity of the electronic device 100.

For still another example, the server 200 may change transmission capacity of the specific content by considering network information of the electronic device 100. In more detail, the server 200 may process the specific content to allow transmission capacity of the content to be reduced. Also, if there is no limitation in data use of the electronic device 100, the server 200 may convert picture quality of the specific content to ultra-high picture quality to allow a user to view contents of high quality.

Conversion of attributes or output format of contents may be expressed as terms such as “process contents” and “convert contents”. Therefore, when the server 200 transmits a specific content to the electronic device 100, the server 200 may transmit the specific content in a format more suitable for the electronic device 100.

If the specific content is processed, the server 200 may transmit the processed specific content (S400), and if the electronic device 100 receives the specific content from the server 200, the electronic device 100 may output the received specific content (S500).

If the specific content is received, the electronic device 100 may output notification information to allow the user to recognize that the specific content has been received. The notification information may be output in a manner previously set to the electronic device 100, and may be output in at least one of visual, auditory and tactile manners.

The electronic device 100 may sequentially output specific contents in response to a user control command for contents output. Alternatively, the electronic device 100 may automatically output specific contents if the specific contents are received.

Meanwhile, referring to (a) of FIG. 6C, the electronic device 100 may search for an external device located in the periphery of the electronic device 100 to be able to output specific contents if the specific contents are not able to be output from the electronic device 100. In this case, the external device located in the periphery of the electronic device 100 is a device that is able to perform short-range communication with the electronic device, and may be located in a place where the user of the electronic device 100 may view or listen to contents output from the external device.

If the external device is searched, the electronic device 100 may output notification information for user selection as to whether contents are output, by using the external device. For example, as shown in (b) of FIG. 6C, if image is received from the server 200 and a TV device having a display unit that may output image is searched, the electronic device 100 may output notification information indicating that “this is image file. Do you want to check it through TV?” in a speech mode.

In this case, the user may input a response signal to the electronic device 100 in response to the notification information. This response signal may be input as speech, touch and button. For example, the user may utter speech such as “yes” after the notification information is output. The controller 180 may analyze the uttered speech of the user through the speech recognition algorithm and control the electronic device 100 in accordance with the analyzed result.

For example, as shown in (c) of FIG. 6C, the electronic device 100 may transmit an image to a TV device if a control command for displaying the image in an external device. If the image is received, the TV device may visually output the image through the display unit. Therefore, in the present invention, even though a content having no format that may be output from the electronic device is received from the server, the electronic device may output the content by using an external device to which the content may be output. Therefore, the user may view or listen to the content in an optimal format by using the electronic device even regardless of the output format of the content.

The method for receiving a content from a server, in which a plurality of contents are stored, has been described as above. In the above description, for the sake of convenience of explanation, it has been described that the output format of the content is determined by a server and transmitted to the electronic device, but the present disclosure is not limited thereto, and the controller of the electronic device may also be formed to determine the output format of the content. In this case, the electronic device may directly generate indexing information based on information associated with the electronic device and user information, and directly determine the output format of the content based on the generated indexing information. The electronic device may also be configured to convert the content to be matched with an output format capability of the output unit if the format of the content is different from the capabilities of the output unit. Furthermore, the electronic device may not transmit information associated with the electronic device and user information to the server.

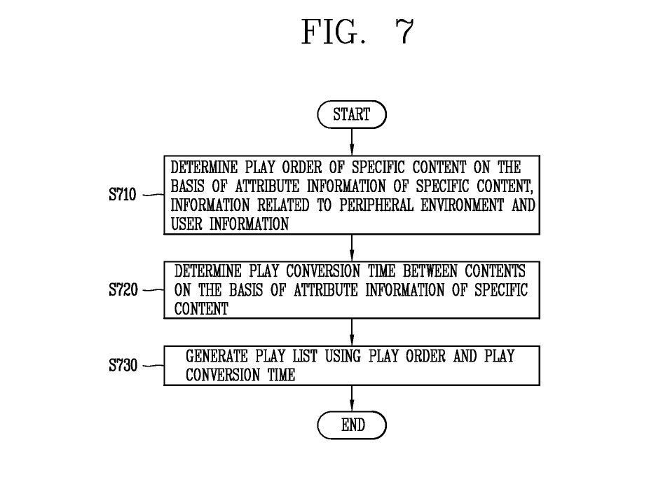

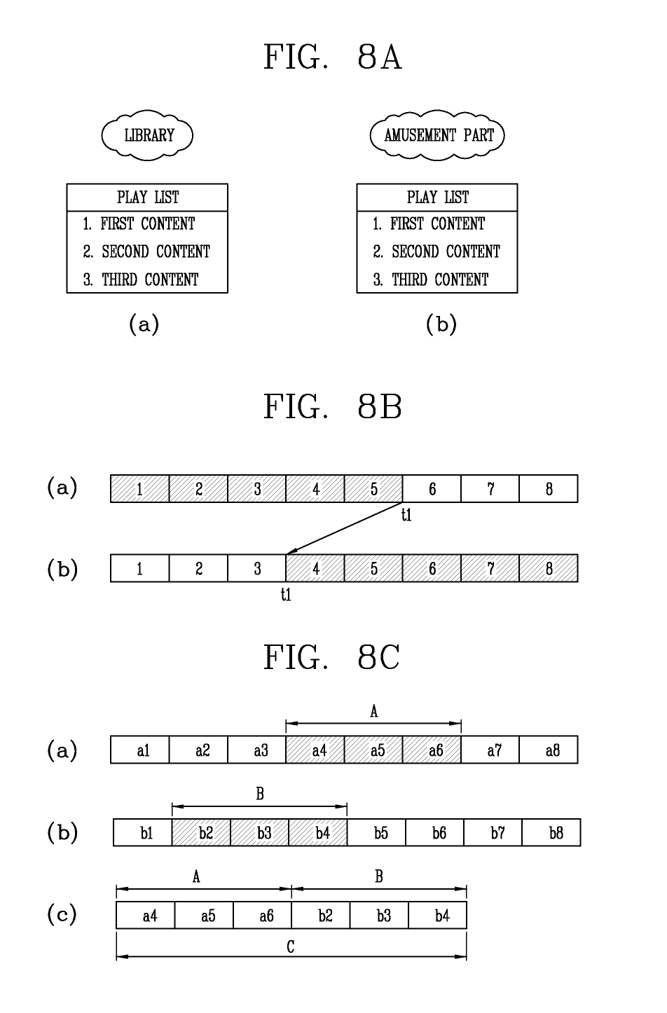

Hereinafter, a method for generating a play list by using a specific content extracted based on user information will be described. FIG. 7 is a flow chart illustrating a method for generating a play list in an electronic device according to the present invention, and FIGS. 8a to 8c are views illustrating contents related to a play list.

The electronic device 100 according to the present invention may include a digital assistant separately from the server 200. Meanwhile, although the following to description will be given based on that the digital assistant which is a part of the controller 180 of the electronic device 100 performs a control operation, the present invention may be applied to a digital assistant provided in the server 200 in the same manner.

First of all, the controller 180 of the electronic device 100 may determine a play order of the specific contents on the basis of attribute information of specific contents, information related to a peripheral environment, and user information (S710).

The electronic device 100 may include a separate memory 170, and the memory 170 may store contents therein. The controller 180 may play the specific contents received from the server 200 and the contents stored in the memory 170 together on the basis of the user request. In this case, the controller 180 may generate a play list that includes the specific contents transmitted from the server and the contents stored in the memory 170. The play list is information indicating the play order of the contents included therein.

The controller 180 may determine the play order among the specific contents downloaded from the server 200 and the contents stored in the memory 170 on the basis of the attribute information of the specific contents, the information related to the peripheral environment and the user information.

The attribute information of the specific contents may include genre information, picture quality, resolution, contrast ratio, definition ratio, texture, color temperature, gamma information, equalizer, transmission capacity, volume, file type, and brightness.

The information related to the peripheral environment is information related to illumination, noise, temperature, humidity, time, place and atmosphere. The information related to the peripheral environment may be sensed through the sensing unit 140 provided in the electronic device 100. For example, the controller 180 may sense peripheral illumination information through a bright sensor. For another example, the controller 180 may sense current position information of the electronic device 100 through a GPS.

The user information may include information related to the user, such as contents taste information preferred by the user, gender, age, and biorhythm.

In more detail, the controller 180 may generate a play list to convert a gentle genre into an exciting genre and then convert the exciting genre into the gentle genre on the basis of genre information of the specific content. Therefore, the user may be recommended a content suitable for his/her taste and also be recommended a play list that may contents in the optimal play order.

Also, the controller 180 may determine the play order on the basis of place information on a place where the electronic device 100 is currently located. For example, as shown in (a) of FIG. 8A, the controller 180 may set the play order (the first content->the second content->the third content) of contents such that the contents are followed by comfortable bits considering a reading condition of a library if the electronic device 100 is located in the library. Also, the controller 180 may set the play order (the second content->the first content->the third content) of contents such that the contents are followed by exciting bits considering an exciting condition of an amusement park if the electronic device 100 is located in the amusement park. Therefore, the user may sequentially appreciate several contents in a format suitable for a place.

Meanwhile, the controller 180 may determine a play conversion time of contents on the basis of the attribute information of the specific contents after setting the play order (S720).

After determining the play order, during play conversion of the first content and the second contents, the controller 180 may determine a random play conversion time such that the first content and the second content may be connected to with each other without starting play of the second content after the play time of the first content ends.

In more detail, as shown in FIG. 8B, the controller 180 may set a play conversion time t1 such that a specific scene (4 in (b) of FIG. 8B) of the second content may be output from a specific scene (5 in (a) of FIG. 8B) of the first content, on the basis of scene information of the contents. In this case, the specific scene of the first content and the specific scene of the second content may be similar to each other in places, may be the same as each other in characters, or may be highlight scenes. Therefore, in the present invention, play conversion time may be set such that natural conversion between the first and second contents may be performed.

The controller 180 may generate a play list of at least one content on the basis of the play order and the play conversion time (S730) and output at least one content in accordance with the generated play list.

Meanwhile, the controller 180 may generate a new content by using the at least one content. In more detail, the controller 180 may extract each highlight scene from the at least one content and generate a new content by collecting highlight scenes. For example, as shown in (a) of FIG. 8C, the controller 180 may extract A parts a4, a5 and a6 from the first content as highlight parts. Also, as shown in (b) of FIG. 8C, the controller 180 may extract B parts b2, b3 and b4 from the second content as highlight parts. Also, as shown in (c) of FIG. 8C, the controller 180 may generate a highlight image C obtained by synthesis of the A parts and the B parts.

At this time, the controller 180 may synthesize the A parts and the B parts such that contents of the A parts may naturally be connected with contents of the B part on the basis of scene information of A and B. For example, if character information appearing in a5 among scenes a4, a5 and 6 of the A parts appears in b3 of the B parts, unlike (c) of FIG. 8C, the highlight image C may be generated such that the scene b3 may appear next to the scene a5.

The method for generating a play list by using at least one content has been described as above. As a result, in the present invention, the contents may be provided in a more optimized format.

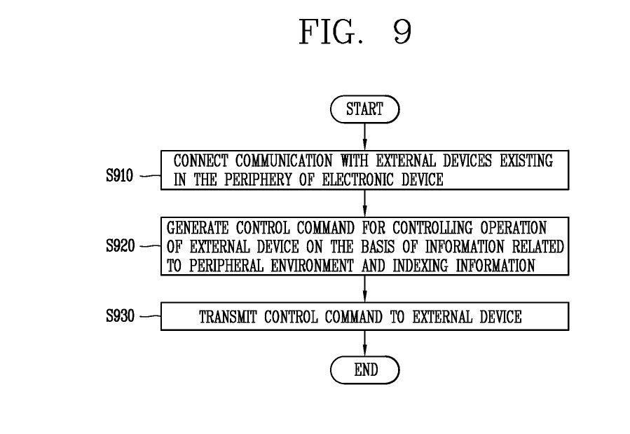

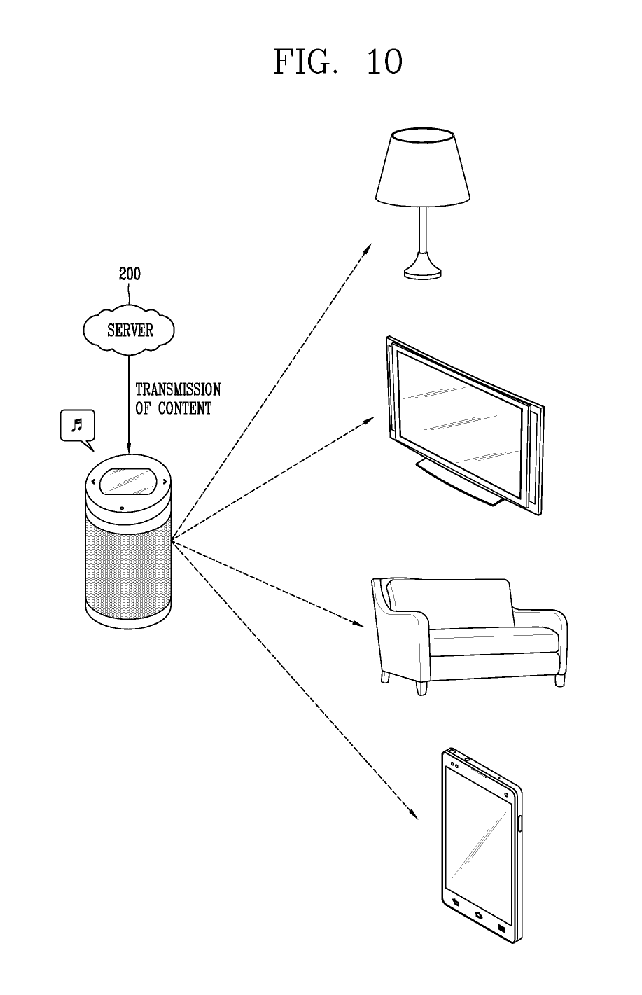

Hereinafter, a method for configuring a peripheral environment optimized for play of contents when the electronic device plays contents will be described. FIG. 9 is a flow chart illustrating a method for configuring a peripheral environment information of an electronic device when contents are played, and FIG. 10 is a conceptual view illustrating a method for controlling external devices to configure a peripheral environment.

Referring to FIG. 9, the controller 180 may perform communication connection with external devices existing in the periphery of the electronic device 100 (S910).

The controller 180 may perform communication connection with the external devices existing in the periphery of the electronic device 100 through short-range communication. In more detail, the controller 180 may transmit a control command for communication connection to the external device, and if a grant signal is received from the external device, the controller 180 may perform communication connection with the external device. Since this communication connection is the same as the conventional connection such as Bluetooth and Wi-Fi, its detailed description will be omitted.

The controller 180 may compare indexing information with peripheral environment information of the current electronic device 100, and may generate at least one control command related to the external device located in the periphery of the electronic device 100 such that the peripheral environment of the electronic device 100 may be matched with a value set to the indexing information (S920).

The indexing information may include peripheral environment information indicating an optimal environment related to the output of contents, as well as optimal output format information of contents. For example, the indexing information may include setting information for setting peripheral illumination and peripheral noise to a reference value or less if the contents corresponds to a horror genre.

The controller 180 may generate the indexing information on the basis of attribute of the contents and pre-learned user information. For example, the controller 180 may generate setting information for setting peripheral illumination to a reference value or more as the indexing information with respect to contents of a horror genre if the user prefers illumination of a reference value or more. Therefore, in the present invention, a peripheral environment suitable for the user's taste may be configured.

The controller 180 may sense peripheral environment information of the current electronic device 100 through the sensing unit 140 after sensing the indexing information. For example, the controller 180 may sense peripheral illumination, peripheral brightness, the number of people located in the periphery of the electronic device, identification of people, noise information, etc. through the sensing unit 140.

The external device located in the periphery of the electronic device 100 is the device related to construction of an optimal environment. For example, if setting information for setting peripheral illumination to a reference value or less is included in the indexing information, the external device is a lamp device. For another example, if setting information for setting peripheral noise to a reference value or less is included in the indexing information, the external device may be an output device related to noise occurrence, such as a speaker and a cleaner. The external device may determine at least one of the external devices, which may perform communication with the electronic device 100, as the external device on the basis of the indexing information.

The controller 180 may generate at least one control command related to the external device, on the basis of the indexing information. For example, the controller 180 may generate a control command for allowing an illumination value of the lamp device to have the reference value or less of the peripheral illumination set to the indexing information. For another example, the controller 180 may generate a control command for allowing a noise occurrence level of the output device related to noise occurrence to have the reference value or less of the peripheral noise set to the indexing information.

If at least one control command related to the external device is generated, the controller 180 may transmit at least one control command to the external device (S930). As shown in FIG. 10, the controller 180 may transmit the generated control command to the corresponding external device to construct a peripheral environment for output of contents. For example, if the control command related to the lamp device is generated, the controller 180 may transmit the control command to the lamp device, and if the control command related to the output device, the controller 180 may transmit the control command to the output device.

If the control command is received from the electronic device 100, the lamp device may set illumination to the reference value or less on the basis of the control command. Likewise, if the control command is received from the electronic device 100, the output device related to noise occurrence may reduce a volume or be powered off on the basis of the control command so that noise generated from the output device may be the reference value or less.

The method for controlling the external devices located in the periphery of the electronic device 100 to configure the peripheral environment of the electronic device 100 as an optimal environment state for viewing or listening to contents has been described as above. Therefore, in the present invention, contents may be provided to a user, who views or listen to the contents through the electronic device 100, in an optimal environment.

Meanwhile, the electronic device 100 according to the present invention may construct the peripheral environment on the basis of the attribute information of the contents but change the attribute information of the contents in accordance with the peripheral environment.

In more detail, if a specific content is output, the controller 180 may change attribute information of the content on the basis of the peripheral environment information of the electronic device 100 and the indexing information.

In this case, the attribute information of the specific content may include character information of the content, summary information, atmosphere information, genre information, scene, picture quality, resolution, contrast ratio, definition ratio, texture, color temperature, gamma information, equalizer, transmission capacity, volume, file type, and brightness.

Also, the information related to the peripheral environment is information related to peripheral environment such as illumination, noise, temperature, humidity, time, place and atmosphere. The information related to the peripheral environment may be sensed through the sensing unit 140 provided in the electronic device 100. For example, the controller 180 may sense peripheral illumination information through a bright sensor. For another example, the controller 180 may sense current position information of the electronic device 100 through a GPS.

For example, if peripheral noise of the electronic device 100 is a specific decibel or less and a content currently output from the electronic device 100 is music of ROCK genre, the controller 180 may change an equalizer of the music to output music of ROCK genre at the specific decibel or less. For another example, if peripheral illumination of the electronic device 100 is a reference value or less and a content currently output from the electronic device 100 is an image, the controller 180 may change brightness of the image to be output at the reference value or less. Change of the attribute information of the contents in accordance with the peripheral environment has been described as above. Therefore, in the present invention, the contents may be output in a suitable output format considering the peripheral environment.

The electronic device according to the embodiment of the present invention may download the specific content suitable for the user's taste from the server in which the plurality of contents are stored. If the output format of the downloaded specific content is different from that of the electronic device, the output format of the specific content may be changed to the suitable format and then output to the output unit of the electronic device, whereby the problem that the content cannot be output due to the different output formats of the contents may be solved.

Also, the electronic device according to another embodiment of the present invention may download at least one content suitable for the user's taste from the server in which the plurality of contents are stored, and may synthesize the downloaded content with the content stored in the memory of the electronic device on the basis of the user information to generate a new content, whereby contents optimized for the user may be produced easily.

Also, in the present invention, when the play list in which the plurality of contents are included is generated, the play order and the play conversion time may be set considering the user information and the atmosphere, whereby more optimal contents may be recommended for the user.

The present invention can be implemented as computer-readable codes in a program-recorded medium. The computer-readable medium may include all types of recording devices each storing data readable by a computer system. Examples of such computer-readable media may include hard disk drive (HDD), solid state disk (SSD), silicon disk drive (SDD), ROM, RAM, CD-ROM, magnetic tape, floppy disk, optical data storage element and the like. Also, the computer-readable medium may also be implemented as a format of carrier wave (e.g., transmission via an Internet). The computer may include the controller 180 of the terminal. Therefore, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. An electronic device comprising:
a communication unit configured to perform communication with an external server storing a plurality of contents;
an output unit configured to output content based on a user control command; and
a controller configured to:
transmit user information to the external server via the communication unit, wherein the user information comprises at least an output capability of the electronic device;
receive a specific content of the stored plurality of contents from the server via the communication unit based on the user information; and
output the received specific content via the output unit,
wherein a stored format of the specific content is converted to an output format corresponding to an output capability of the electronic device when it is determined, based on the user information, that the electronic device is not capable of outputting the stored format of the specific content.

2. The electronic device according to claim 1, further comprising a sensor unit configured to detect information related to a peripheral environment of the electronic device, wherein the controller is further configured to determine the output format based on the detected information related to the peripheral environment.

3. The electronic device according to claim 2, wherein the controller is further configured to change an attribute of the specific content based on the detected information related to the peripheral environment.

4. The electronic device according to claim 3, wherein the attribute of the specific content comprises character information of the content, summary information, atmosphere information, scene information, genre information, scene, picture quality, resolution, contrast ratio, definition ratio, texture, color temperature, gamma information, equalizer, transmission capacity, volume, file type, or brightness of the specific content.

5. The electronic device according to claim 2, wherein the information related to the peripheral environment comprises peripheral illumination, peripheral noise, peripheral temperature, peripheral humidity, time, place, or atmosphere information.

6. The electronic device according to claim 2, wherein
the specific content is converted to the output format based on generated indexing information and the information related to the peripheral environment, wherein the indexing information is related to the output format based on attribute information of the specific content.

7. The electronic device according to claim 6, wherein the indexing information comprises output format information of a content, optimal output format information, or peripheral environment information of a content.

8. The electronic device according to claim 1, wherein the controller is further configured to cause the output unit to:
output generated speech information corresponding to visual information of the specific content, wherein the generated speech information is generated based on a preset image recognition algorithm when the specific content comprises only visual information, and
output only predefined speech information of the specific content when the specific content comprises both visual information and the predefined speech information.

9. The electronic device according to claim 2, wherein the controller is further configured to:
perform communication, via the communication unit, with at least one external device located near the electronic device; and
control an operation of the external device based the detected information related to the peripheral environment when the specific content is output via the output unit.

10. The electronic device according to claim 9, wherein the controller is further configured to generate a control command for controlling the operation of the external device and transmit the generated control command to the external device.

11. The electronic device according to claim 1, wherein the controller is further configured to:
search for an external device which is capable of outputting the specific content in the stored format; and
output notification information via the output unit indicating that the specific content may be output via the external device.

12. The electronic device according to claim 1, further comprising a memory configured to store information, wherein the controller is further configured to:
extract at least one stored content stored in the memory; and
generate new content comprising the extracted at least one stored content and one or more of the plurality of stored contents stored at the external server.

13. The electronic device according to claim 12, wherein the controller is further configured to identify portions of the at least one stored content and the one or more of the plurality of stored contents based on the user information comprising user preference information related to particular types of content,
wherein the generated new content is generated by combining the identified portions.

14. The electronic device according to claim 1, wherein the controller is further configured to determine attribute information of at least a content having a play history, a content having a reading history, or a content having a viewing history.

15. A content providing system comprising:
a server storing a plurality of contents; and
a mobile terminal configured to receive a specific content of the stored plurality of contents from the server and output the received specific content,
wherein the server is configured to:
select the specific content from the stored plurality of contents based on user information of the mobile terminal;
set an output format of the extracted specific content based on a content output format of the mobile terminal; and
transmit the specific content having the set output format to the mobile terminal for output by the mobile terminal.

16. The content providing system according to claim 15, wherein:
the mobile terminal is further configured to transmit information related to a peripheral environment of the mobile terminal to the server; and
the server is further configured to set the output format of the specific content based on the transmitted information related to the peripheral environment of the mobile terminal.
